(19) United States
(12) Patent Application Publication
(10) Pub. No.: US 2017/0326824 A1
(43) Pub. Date: Nov. 16, 2017

(54) Agent for Provisionally Sealing Inflatable or Pressurizable Objects and Method for Provisionally Sealing Inflatable or Pressurizable Objects

(71) Applicant: Continental Reifen Deutschland GmbH, Hannover (DE)

(72) Inventor: Philip Mathias Bialach, Hannover (DE)

(73) Assignee: Continental Reifen Deutschland GmbH, Hannover (DE)

(21) Appl. No.: 15/526,767

(22) PCT Filed: Sep. 9, 2015
(86) PCT No.: PCT/EP2015/070545

§ 371 Date: May 15, 2017

(30) Foreign Application Priority Data
Dec. 1, 2014 (DE) 10 2014 224 491.9

(51) Int. Cl. B29C 73/16; C09D 7/12; C09D 5/34; C09D 107/02; B29C 73/02; C08K 5/053

(52) U.S. Cl. CPC B29C 73/163; C09D 107/02; C09D 7/125; C09D 7/1233; C09D 5/34; C08K 5/053; B29C 73/025

(57) ABSTRACT

The invention relates to an agent for provisionally sealing inflatable or pressurizable objects, in particular pneumatic vehicle tyres, containing at least one rubber latex and at least a first antifreeze. The invention also relates to a method for provisionally sealing inflatable or pressurizable objects, in particular pneumatic vehicle tyres. The agent has a total solids content of rubber latex and adhesive resin of 3 to 30% by weight and the antifreeze is/are selected from the group consisting of 1,2-propane diol and 1,3-propane diol and 1,2-butane diol and 1,3-butane diol and glycerin and triethylene glycol and 0 to 9% by weight ethylene glycol.

The invention relates to a composition for temporary sealing of articles inflatable by blowing or pumping, especially of motor vehicle pneumatic tires, comprising at least one rubber latex and at least one first antifreeze. The invention further relates to a method of temporary sealing of articles inflatable by blowing or pumping, especially of motor vehicle pneumatic tires.

A motor vehicle pneumatic tire when run over sharp articles can suffer damage in the form of cracks or holes which lead to the loss of air pressure in the tire. In order to seal such damage at least temporarily, i.e. for a certain period of time before the motor vehicle pneumatic tire can be changed, with maximum reliability, there are known sealants which are introduced into the tire, for example with the aid of a device with a pressure source and sealant, after the valve insert has been screwed out or directly via the valve.

Sealants comprising rubber latex and an antifreeze are known, for example, from DE 195 42 935 A1, DE 197 53 630 A1, DE 198 44 177 A1 and U.S. Pat. No. 4,501,825. Antifreezes proposed in these documents are glycols, for example ethylene glycol or propylene glycol. DE 198 44 177 A1 also discloses the simultaneous use of two different liquid diols, for example ethylene glycol and dipropylene glycol, as antifreeze in sealants. The antifreezes proposed in these documents have a density of more than 1 g/cm³.

WO 2008/034657 A1 discloses a sealant wherein the antifreeze has a density of not more than 1 g/cm³. Such a sealant enables sealing even at low temperatures and has an improved shelf life.

In order to suppress the phenomenon of creaming in the case of latex-containing sealants, EP 1 291 159 B 1 discloses using 20% to 40% by weight, based on the total weight of the sealant, of propylene glycol in place of ethylene glycol.

However, propylene glycol can lead to elevated preliminary crosslinking of the latex, especially at elevated temperature, and hence greatly restrict the flowability and pumpability of the sealant. This effect is enhanced in the case of a higher latex content or higher solids content.

It is an object of the invention to provide a composition for temporary sealing of articles inflatable by blowing or pumping, especially of motor vehicle pneumatic tires, which has optimized flowability and pumpability and at the same time relatively low production costs. At the same time, it is to contain minimum amounts of substances that harm the environment and are hazardous to health.

This object is achieved in accordance with the invention in that the composition for temporary sealing of articles inflatable by blowing or pumping has a total solids content of rubber latex and tackifying resin of 3% to 30% by weight and the antifreeze(s) is/are selected from the group consisting of propane-1,2-diol and propane-1,3-diol and butane-1,2-diol and butane-1,3-diol and glycerol and triethylene glycol and 0% to 9% by weight of ethylene glycol.

For the sake of simplicity, the “composition for temporary sealing of articles inflatable by blowing or pumping” in the context of the present invention is also referred to as “sealant”.

The combination of low solids content with the abovementioned antifreezes achieves very good sealing performance, coupled with smaller amounts of material and hence lower material and production costs. The rubber latex present and the tackifying resin present are more efficient in the combination specified, and so a smaller amount is needed. An essential feature that the antifreezes mentioned have in common is the property of very good binding of water. At the same time, the antifreezes mentioned, compared to antifreezes known from the prior art, are more environmentally friendly and less hazardous to health.

Unless stated otherwise, all weight data are based on the total amount of sealants or on the total amount of compositions for temporary sealing of articles inflatable by blowing or pumping.

Preferably, the sealant of the invention additionally comprises at least one surfactant mixture. The surfactant mixture preferably comprises at least one surfactant which is matched to the latex and stabilizes it, and at least one surfactant which stabilizes the at least one antifreeze. The surfactant mixture thus achieves further stabilization of the sealant. Moreover, at least one surfactant is a foam former, such that the surfactant mixture preferably causes elevated foam formation after being pumped through the tire valve, which leads to a locally increased solids concentration at the tire surface. This promotes gelation at the sealing site and hence the sealing.

Preferably, the longest chain length (greatest number of carbon atoms joined to one another in a linear manner) of the surfactants corresponds roughly to the longest chain length (greatest number of carbon atoms joined to one another in a linear manner) of the antifreeze or the latex correspond, which results in corresponding compatibility for stabilization.

Preferably, the surfactant mixture comprises one or more sulfonate surfactants, preferably anionic mono- or disulfonates, and/or one or more alkylaryl ether sulfates, for example sodium trialkylphenol polyethylene glycol ether sulfate, and at least one steric surfactant.

Sulfonate surfactants such as mono- or disulfonates and, for example, sodium trialkylphenol polyethylene glycol ether sulfate are good foam formers. Among the sulfonates, preference is given to disulfonates, since a higher efficiency in relation to the stabilization is achieved thereby.

As described above, the steric surfactants are selected according to their compatibility with the antifreeze(s) used, i.e. preferably on the basis of the chain length(s). The steric surfactants may be any steric surfactants known to those skilled in the art, such as, more particularly, alcohol ethoxylates and/or ethylene oxide-propylene oxide block copolymers. The steric surfactants preferably have a viscosity- and foam-regulating effect. The amount of steric surfactants present is 0% to 3% by weight. In a preferred embodiment of the invention, it is 0.1% to 3% by weight, more preferably 1% to 3% by weight, most preferably 1.0% to 2.5% by weight.

The amount of sulfonate surfactants present, preferably anionic mono- or disulfonates, is 0% to 3% by weight. In a preferred embodiment of the invention, it is 0.1% to 3% by weight, more preferably 1% to 3% by weight, most preferably 1.2% to 2.5% by weight.

The amount of alkylaryl ether sulfates, preferably glycol ether sulfates, present is 0% to 3% by weight. In a preferred embodiment of the invention, it is 0.1% to 3% by weight, more preferably 1% to 3% by weight, most preferably 1.2% to 2.5% by weight.

In a particularly advantageous development of the invention, the sealant contains:

1.2% to 2.5% by weight of sulfonate surfactants, preferably anionic mono- or disulfonates, more preferably anionic disulfonates, and/or

1.2% to 2.5% by weight of alkylaryl ether sulfates, preferably glycol ether sulfates, and

1.0% to 2.5% by weight of at least one steric surfactant.

A sealant comprising such a surfactant mixture, especially when used in motor vehicle pneumatic tires, surprisingly exhibits easy aerosol formation when sprayed through the valve of the article to be sealed. During the pumping-up operation, the sealant aerosol moves to the puncture site, especially of a motor vehicle pneumatic tire, and begins to seal the hole. The larger the leak, the greater the effect. The particular advantage here is considered to be that the leak is reduced in size even during the pumping-up operation and hence the pumping-up time is significantly shortened.

Moreover, in the case of optimal aerosol formation, immediate sealing of the leak is achieved even during the pumping-up operation.

In addition, it is thus also possible for even low-power compressors to pump up a tire with an initially large leak to the desired air pressure.

The total amount of antifreeze in the sealant, i.e. covering all antifreezes, in a preferred development of the invention, is 1% to 50% by weight, more preferably 10% to 50% by weight, most preferably 20% to 50% by weight. Particularly a total amount of 10% by weight or more of antifreeze ensures adequate protection from freezing at cold ambient temperatures on application, preferably in a motor vehicle pneumatic tire. In the case of warmer ambient temperatures, however, total amounts of antifreeze of less than 10% by weight are also conceivable.

Preferably, the amount of each of the individual antifreezes mentioned apart from ethylene glycol, however, is up to 25% by weight, i.e. 0.1% to 25% by weight. According to the invention, the amount of ethylene glycol is only up to 9% by weight if ethylene glycol is present.

The effect of an amount of more than 25% by weight of just one antifreeze is that unwanted properties of the particular antifreeze are too dominant and hence difficult to compensate for.

If propane-1,2-diol is present as antifreeze, the amount is preferably 0.1% to 25% by weight, more preferably 0.1% to 19% by weight.

If propane-1,3-diol is present as antifreeze, the amount is preferably 0.1% to 25% by weight, more preferably 0.1% to 19% by weight.

If butane-1,3-diol is present as antifreeze, the amount is preferably 0.1% to 25% by weight.

If glycerol (propane-1,2,3-triol) is present as antifreeze, the amount is preferably 0.1% to 20% by weight.

Moreover, the sealant may, in accordance with the invention, contain up to 9% by weight of ethane-1,2-diol (ethane-1,2-diol is another name for ethylene glycol). In a preferred embodiment of the invention, the sealant, however, contains 0% by weight of ethylene glycol and is thus free of ethylene glycol.

Said total solids content of rubber latex and tackifying resin of 3% to 30% by weight relates only to the solids from the latex/latices used and the tackifying resin(s) used and is determined on the basis of the starting weights of the materials used.

The other solids contents of the substances present in the sealant, especially those present in the surfactant mixture, do not count toward the total solids content.

According to the invention, the total solids content of rubber latex and tackifying resin is 3% to 30% by weight. Preferably, the total solids content of rubber latex and tackifying resin is 8% to 30% by weight, more preferably 14% to 20% by weight.

The composition of the invention for temporary sealing of articles inflatable by blowing or pumping comprises at least one rubber latex. The rubber latex may be natural rubber latex from Hevea brasiliensis or else latex from the guayule shrub (Parthenium argentatum). The natural rubber latex may also be used in deproteinized form. It can be used as latex, or else a latex from synthetic rubbers. The use of different latices in a blend is likewise possible.

In an advantageous development of the invention, the latex/latices used for the sealant has/have a solids content of 40% to 75% by weight, preferably 55% to 65% by weight, more preferably 60% by weight, and is/are used in the production of the composition in an amount of 2% to 35% by weight, based on the total weight of the composition for sealing. These latices have good processibility to give the sealant and, in the amounts specified, assure good pump- and injectability of the sealant into the article to be sealed with simultaneously good sealing action.

To improve the sealing action and the shelf life, the sealant comprises at least one tackifying resin.

It is also possible to use two or more tackifying resins in a mixture, in which case the resins are preferably used as a 45% to 60% by weight, preferably 45% to 55% by weight, more preferably 50% by weight, aqueous dispersion (emulsion) in an amount of 2% to 20% by weight, preferably 2% to 16% by weight, based on the total weight of the composition for sealing. Tackifying resins used may be natural or synthetic resins, such as hydrocarbon resins, that act as tackifiers. The tackifying resins are preferably selected from the group consisting of rosins and esters thereof, terpene-phenol resins, alkyne-phenol resins, phenolic resins and coumarone-indene resins. Sealants comprising these tackifying resins exhibit particularly high bond strength with good sealing action and have a positive effect on the compatibilization with other components of the sealant.

Rosin, which can be obtained from the tree resin of various conifers, consists essentially of a mixture of resin acids and terpenes. The esterification of the corresponding constituents of rosin is effected in a conventional manner. For example, it is conceivable to react the rosin with alcohols or alcohol mixtures. It is also possible that certain constituents, for example abietic acid, dehydroabietic acid, tetrahydroabietic acid, dihydroabietic acid, and isomers and/or mixtures thereof are obtained from the rosin and these constituents are reacted individually or together with alcohols or alcohol mixtures. The alcohols used are preferably, for example, methanol, ethanol, propane-1,2,3-triol and/or pentaerythritol.

Terpene-phenol resins are those resins which are prepared by acid-catalyzed addition of phenols onto terpenes.

Alkyne-phenol resins that may be used are resins containing ethyne, for example, as the alkyne and butylphenol or novolaks formed from formaldehyde and, for example, p-tert-butylphenol (or p-diisobutylphenol), for example, as the phenol component.

Coumarone-indene resins are obtained as copolymers in the polymerization of the unsaturated compounds present in the light oil of heavy coal tar.

Moreover, the sealant may contain, in addition to the liquids present in the latex and tackifying resin, one or more solvents in amounts of up to 40% by weight.

In a preferred embodiment of the invention, the amount of additional solvents is 10% to 40% by weight, more preferably 10% to 30% by weight, most preferably 18% to 28% by weight.

The solvent(s) may be protic nonacidic solvents, such as, more particularly, water and/or alcohols, preference being given to water.

The sealant may comprise further customary additives in customary amounts. For instance, it is possible for aging stabilizers or preservatives to be added to the sealant to make sure that the sealant will be ready for use in the case of storage. In addition, the sealant may comprise dispersants, emulsifiers and pH regulators.

Preferably, the sealant contains 1% to 2% by weight of at least one aging stabilizer, such as, more particularly, dispersions of sterically hindered and alkylated (poly)phenols and/or alkylated diphenylamines.

It is also possible to add fillers to the sealant, which contribute to the sealing particularly of relatively large holes. Fillers used may, for example, be fibrous materials (natural or synthetic fibers), sheet silicates, silica, talc, chalk, carbon black, ground rubber or the like.

The sealant of the invention can be produced, for example, by initially charging a stirred tank with the latex and mixing in a tackifying resin dispersion. After metered addition of any other constituents, such as dispersants, emulsifiers, foam stabilizers, surfactants, pH regulators and fillers, the antifreeze is added to the latex in the last step, optionally in water-diluted form, while stirring.

The sealant preferably has a viscosity (dynamic viscosity according to Brookfield, spindle 1, 60 rpm) at 23° C. of 10 to 30 mPa·s.

The sealant can be used for sealing articles that can be inflated by blowing or pumping, for example balls. However, particular preference is given to the use of the sealant for subsequent sealing of motor vehicle pneumatic tires, wherein, in the event of damage, it is conveyed into the interior of the tire through the valve of the motor vehicle pneumatic tire by means of devices known from the prior art (see, for example, WO 02066236 A1). Preferably, the motor vehicle pneumatic tire is a tubeless motor vehicle pneumatic tire.

The invention further relates to a method of temporary sealing of articles inflatable by blowing or pumping, using the above-described composition including all its preferred embodiments and developments.

The invention preferably relates to a method of temporary sealing of motor vehicle pneumatic tires.

Preferably, the composition is sprayed in in the method through the valve of the article which is inflatable by blowing or pumping and is to be sealed, preferably the motor vehicle pneumatic tire.

This method in combination with the composition of the invention has the advantage of surprisingly easy aerosol formation on spraying-in. During the pumping-up operation, the sealant aerosol moves to the puncture site, especially of a motor vehicle pneumatic tire, and begins to seal the hole. The larger the leak, the greater the effect. The particular advantage here is considered to be that the leak is reduced in size even during the pumping-up operation and hence the pumping-up time is significantly shortened. Moreover, in the case of optimal aerosol formation, immediate sealing of the leak is achieved even during the pumping-up operation.

In addition, it is thus also possible for even low-power compressors to pump up a tire with an initially large leak to the desired air pressure.

For this purpose, the composition more preferably contains 1.2% to 2.5% by weight of sulfonate surfactants, preferably anionic mono- or disulfonates, more preferably anionic disulfonates, and/or

1.2% to 2.5% by weight of alkylaryl ether sulfates, preferably glycol ether sulfates, and

1.0% to 2.5% by weight of at least one steric surfactant.

More particularly, such a surfactant mixture achieves the advantage of reducing the size of or even sealing the leak even during the pumping-up operation.

The invention is to be elucidated in detail with reference to the working examples which follow.

Sealants from the prior art are identified as comparative examples by “C”. Compositions of the invention are identified by “I”.

The Brookfield viscosity of the respective sealants was determined.

In addition, the sealing effect was determined as the maximum leakage rate. The leak is made with the aid of a 6 mm nail at temperatures of −40° C. to +70° C., and the pressure drop proceeding from the tire fill pressure of 2.5 bar is measured. The compositions and results are compiled in table 1.

Substances Used

^{a)} solids content 60% by weight, LATZ natural latex, e.g. Weber & Schaer

^{b)} rosin ester, solids content 50% by weight, Tacolyn, Eastman Chemical Company

^{c)} aromatically modified terpene resin, Nanolet TO, Yasuhara chemical Co. Ltd

^{d)} alkylated (poly)phenol

^{e)} anionic disulfonate, active solids content 30% by weight

^{f)} sodium trialkylphenol polyethylene glycol ether sulfate

^{g)} polyoxyethylene(25) cetylstearyl ether

^{h)} solvent: water

ⁱ⁾ solids content of rubber latex and tackifying resins (a) to (c)

TABLE 1

| Constituents | Unit | C1 | C2 | I1 | I2 | I3 | I4 |
|---|---|---|---|---|---|---|---|
| Natural rubber latex ^{a)} | % by wt. | 60 | 60 | 25 | 25 | 15 | 25 |
| Tackifying resin ^{b)} | % by wt. | — | 20 | 9 | 8 | 6 | 8 |
| Tackifying resin ^{c)} | % by wt. | 20 | — | — | — | — | — |
| Aging stabilizer ^{d)} | % by wt. | — | 1 | 1 | 1 | 1 | 1 |
| Surfactant ^{e)} | % by wt. | — | 1 | 2 | — | 2 | 2 |
| Surfactant ^{f)} | % by wt. | — | — | 2 | 2 | 2 | 2 |
| Steric stabilizer ^{g)} | % by wt. | — | — | 1 | 2 | — | 2 |
| Ethane-1,2-diol | % by wt. | 20 | 16 | 9 | 9 | 9 | — |
| Propane-1,2-diol | % by wt. | — | — | 19 | 19 | 14 | 19 |
| Propane-1,3-diol | % by wt. | — | — | — | — | 5 | — |
| Butane-1,3-diol | % by wt. | — | — | 12 | 10 | 10 | 20 |
| Glycerol | % by wt. | — | — | — | 4 | 10 | — |
| Solvent ^{h)} | % by wt. | — | — | 20 | 20 | 26 | 21 |
| Solids content ⁱ⁾ | % by wt. | 45 | 45 | 20 | 20 | 12 | 20 |
| Properties | | | | | | | |
| Viscosity at 23° C. | mPa•s | 35 | 30 | 16 | 18 | 25 | 20 |
| Max. leakage rate | bar/min | 1 | 1.4 | 2 | 2 | 2 | 2 |

With the inventive sealants I1 to I4, it is possible to reliably seal motor vehicle pneumatic tires after damage. As apparent in table 1, the sealants of the invention have a comparatively low viscosity, which gives rise to optimal flow characteristics on use, preferably in a motor vehicle pneumatic tire, and optimal pumpability.

In addition, the sealant, compared to sealants comprising a greater amount of ethylene glycol, has a zero or reduced hazardous substance potential according to the EU standard (EU no. 1272/2008).

1.-11. (canceled)

12. A temporary sealing composition comprising at least one rubber latex, at least one tackifying resin and at least two different antifreezes, wherein total solids content of the rubber latex and tackifying resin is from 3% to 30% by weight;
wherein the at least two different antifreezes are selected from the group consisting of propane-1,2-diol, propane-1,3-diol, butane-1,2-diol, butane-1,3-diol, glycerol, triethylene glycol and up to 9% by weight of ethylene glycol; and,
wherein an article is inflated by blowing or pumping the temporary sealing composition therein.

13. The temporary sealing composition as claimed in claim 12 further comprising at least one surfactant mixture.

14. The temporary sealing composition as claimed in claim 12, wherein the amount of any of the propane-1,2-diol, propane-1,3-diol, butane-1,2-diol, butane-1,3-diol, glycerol, or triethylene glycol is 0.1% to 25% by weight when incorporated, based on the total weight of the temporary sealing composition.

15. The temporary sealing composition as claimed in claim 12, wherein the at least one rubber latex has a solids content of 40% to 75% by weight and is incorporated in the temporary sealing composition in an amount of 3% to 35% by weight, based on the total weight of the temporary sealing composition.

16. The temporary sealing composition as claimed in claim 12, wherein the at least one tackifying resin is incorporated into the temporary sealing composition in an amount of 2% to 20% by weight, based on the total weight of the temporary sealing composition, and wherein the at least one tackifying resin comprises 45% to 60% by weight of an aqueous dispersion.

17. The temporary sealing composition as claimed in claim 12, wherein the at least one tackifying resin is selected from the group consisting of rosins and esters thereof, terpene-phenol resins, alkyne-phenol resins, phenolic resins and coumarone-indene resins.

18. The temporary sealing composition as claimed in claim 12, wherein the article is a motor vehicle pneumatic tire.

19. A temporary sealing composition comprising at least one rubber latex, at least one tackifying resin and at least two different antifreezes, a surfactant mixture, wherein total solids content of the rubber latex and tackifying resin is from 3% to 30% by weight;
wherein the surfactant mixture comprises one or more sulfonate surfactants or one or more alkylaryl ether sulfates, and at least one steric surfactant;
wherein the at least two different antifreezes are selected from the group consisting of propane-1,2-diol, propane-1,3-diol, butane-1,2-diol, butane-1,3-diol, glycerol, triethylene glycol and up to 9% by weight of ethylene glycol; and,
wherein an article is inflated by blowing or pumping the temporary sealing composition therein.

20. The temporary sealing composition as claimed in claim 19, wherein the amount of any of the propane-1,2-diol, propane-1,3-diol, butane-1,2-diol, butane-1,3-diol, glycerol, or triethylene glycol is 0.1% to 25% by weight when incorporated, based on the total weight of the temporary sealing composition.

21. The temporary sealing composition as claimed in claim 19, wherein the at least one rubber latex has a solids content of 40% to 75% by weight and is incorporated in the temporary sealing composition in an amount of 3% to 35% by weight, based on the total weight of the temporary sealing composition.

22. The temporary sealing composition as claimed in claim 19, wherein the at least one tackifying resin is incorporated into the temporary sealing composition in an amount of 2% to 20% by weight, based on the total weight of the temporary sealing composition, and wherein the at least one tackifying resin comprises 45% to 60% by weight of an aqueous dispersion.

23. The temporary sealing composition as claimed in claim 19, wherein the at least one tackifying resin is selected from the group consisting of rosins and esters thereof, terpene-phenol resins, alkyne-phenol resins, phenolic resins and coumarone-indene resins.

24. The temporary sealing composition as claimed in claim 19, wherein the article is a motor vehicle pneumatic tire.

25. A temporary sealing composition comprising at least one rubber latex, at least one tackifying resin and at least two different antifreezes, a surfactant mixture, wherein total solids content of the rubber latex and tackifying resin is from 3% to 30% by weight;
wherein the surfactant mixture comprises one or more sulfonate surfactants, one or more alkylaryl ether sulfates, and at least one steric surfactant;
wherein the at least two different antifreezes are selected from the group consisting of propane-1,2-diol, propane-1,3-diol, butane-1,2-diol, butane-1,3-diol, glycerol, triethylene glycol and up to 9% by weight of ethylene glycol; and,
wherein an article is inflated by blowing or pumping the temporary sealing composition therein

26. The temporary sealing composition as claimed in claim 25, wherein the amount of any of the propane-1,2-diol, propane-1,3-diol, butane-1,2-diol, butane-1,3-diol, glycerol, or triethylene glycol is 0.1% to 25% by weight when incorporated, based on the total weight of the temporary sealing composition.

27. The temporary sealing composition as claimed in claim 25, wherein the at least one rubber latex has a solids content of 40% to 75% by weight and is incorporated in the temporary sealing composition in an amount of 3% to 35% by weight, based on the total weight of the temporary sealing composition.

28. The temporary sealing composition as claimed in claim 25, wherein the at least one tackifying resin is incorporated into the temporary sealing composition in an amount of 2% to 20% by weight, based on the total weight of the temporary sealing composition, and wherein the at least one tackifying resin comprises 45% to 60% by weight of an aqueous dispersion.

29. The temporary sealing composition as claimed in claim 25, wherein the at least one tackifying resin is selected from the group consisting of rosins and esters thereof, terpene-phenol resins, alkyne-phenol resins, phenolic resins and coumarone-indene resins.

30. The temporary sealing composition as claimed in claim 25, wherein the article is a motor vehicle pneumatic tire.
